(19) United States
(12) Patent Application Publication
(10) Pub. No.: US 2012/0209458 A1
(43) Pub. Date: Aug. 16, 2012

(54) SYSTEMS AND METHODS FOR VERIFYING AN AVAILABLE RUNWAY LENGTH

(75) Inventor: Mahesh Kumar Sampath, Villupuram (IN)

(73) Assignee: HONEYWELL INTERNATIONAL INC., Morristown, NJ (US)

(21) Appl. No.: 13/026,832

(22) Filed: Feb. 14, 2011

(51) Int. Cl. G06G 7/76; G06F 19/00

(52) U.S. Cl. 701/14; 701/15

(57) ABSTRACT

A system and method for verifying an available runway length is provided. The method may include receiving, by a processor, a digital notice to airmen including an available runway length, receiving, by the processor, takeoff data or landing data including a length of runway needed by an aircraft in any configuration, and verifying, by the processor, and alerting the pilot if that the available runway length is greater than or equal to the length of runway needed by the aircraft in the configuration.

### TECHNICAL FIELD

The following relates to aircraft takeoff and landing systems and methods for operating the same, and more particularly relates to systems and methods for verifying an available runway length.

### BACKGROUND

Prior to takeoff or landing, a flight crew typically verifies which runway the aircraft will be using with air traffic control authorities. The runway may be manually or electronically loaded into the aircraft's Flight Management System (“FMS”) prior to takeoff or landing.

Prior to departure, in the process of compiling a flight plan, the air crew generally reviews daily message traffic referred to as a notice to airmen (“NOTAM”). A NOTAM message is a formatted message that is filed with an aviation authority to alert aircraft pilots of any hazards located along their flight plan or at a specific location. The NOTAM may also indicate that an available runway length for a given runway has been reduced due to, for example, snow or ice.

Traditionally, pilots receive multiple NOTAMs in paper or electronic form to be manually deciphered and evaluated. Information that is relevant to their specific flight plan is then extracted by the pilot and included in the flight plan. Such paperwork is time consuming and tedious. Further, NOTAMS that have been issued after takeoff may not be available to the pilot unless such ate breaking NOTAM updates are transmitted directly to the aircraft and considered. If a runway is operating at a reduced length, air traffic control typically verbally alerts the pilots to the new conditions or issues new electronic NOTAMS which the pilot would have to decipher to discover the reduced runway length and then enter the reduced runway length into the FMS.

### DESCRIPTION OF THE DRAWING FIGURES

Exemplary embodiments will hereinafter be described in conjunction with the following drawing figures, wherein like numerals denote like elements, and

FIG. 1 is a block diagram of an exemplary system in accordance with an embodiment;

FIG. 2 is a flow chart illustrating operation of an exemplary system in accordance with an embodiment; and

FIG. 3 is an exemplary multipurpose control display unit, in accordance with an embodiment.

### DETAILED DESCRIPTION

According to various exemplary embodiments, systems and methods are provided to automatically verify that an available length of runway is greater than or equal to a calculated needed runway length for an aircraft to takeoff or land. As discussed in greater detail below, in certain instances an available length of runway may be less than the overall length of runway, for example, if there is snow or ice at one end of a runway.

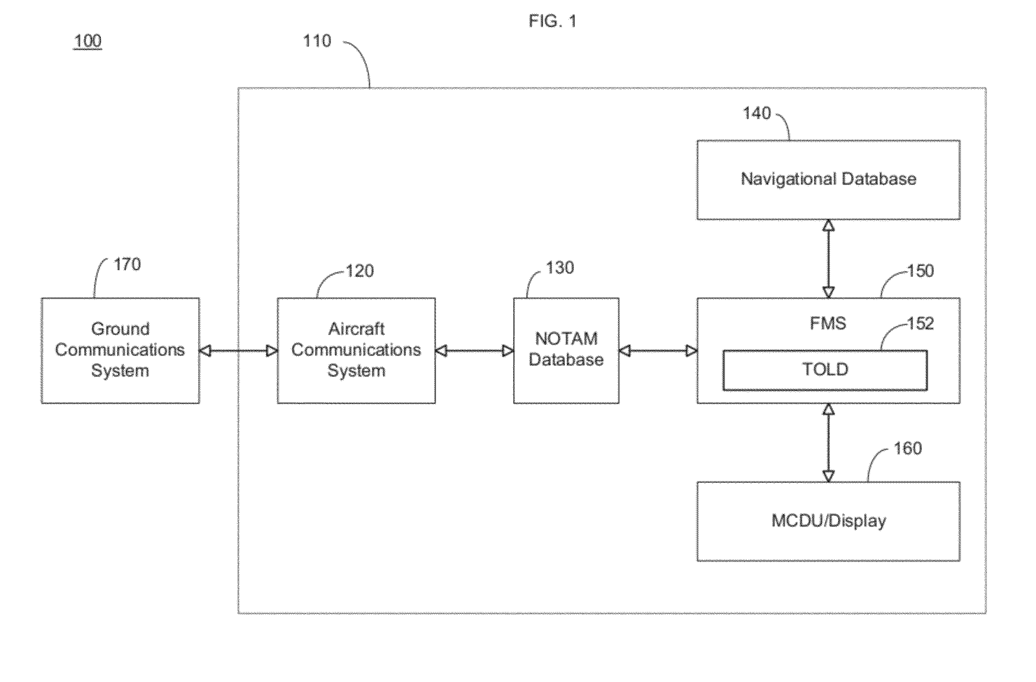

FIG. 1 is a block diagram of an exemplary system 100 for verifying that an available runway length is greater than or equal to a calculated runway length needed for takeoff or landing of an aircraft 110 in accordance with an embodiment. The aircraft 110 may be any type of aircraft, spacecraft or non-terrestrial vehicle. The aircraft 110 includes a communications system 120 capable of transmitting and receiving voice and data. The communications system may use, for example, radio frequency communication, Wi-Fi, Bluetooth or other transmission method, or any combination thereof.

As discussed in further detail below, the communications system 120 may receive digital notice to airmen (“NOTAM”) data. Digital NOTAM may be issued, for example, by a government agency or by airport operators and may be used to inform pilots of important data regarding a particular location. For example, digital NOTAM may be used to inform pilots of hazards such as air-shows, parachute jumps, kite flying, rocket launches, temporary flight restrictions, closed runways, inoperable radio navigational aids, military exercises with resulting airspace restrictions, inoperable lights on tall obstructions, temporary erection of obstacles near airfields (e.g. cranes), passage of flocks of birds through airspace, notification of an operationally significant change in volcanic ash or other dust contamination, or any other data which could effect takeoff, landing or taxiing operations of an aircraft.

In particular, digital NOTAM may be issued to inform pilots of an available runway length for a takeoff or landing. A runway length may be affected, for example, by snow, ice or standing water as well as equipment or personnel which may be on the runway. The available runway length may also be affected, for example, by construction.

The available runway length can be stored, for example, in a NOTAM database 130 on the aircraft 110. Expiration data may be assigned to the stored runway length, indicating, for example, how long the stored data is valid. In one exemplary embodiment, the NOTAM database 130 may be independent of other databases on the aircraft 110. In other embodiments, for example, the NOTAM database 130 can be integrated into other databases or systems such as a navigational database 140, as discussed in further detail below.

The aircraft 110 also includes a flight management system 150 (“FMS”). FMSs are used in modern aircraft to reduce the burden on pilots. FMSs are capable of assisting the pilot in a wide variety of in flight tasks. For example, the FMS 150 may be connected to a global positioning system (“GPS”) to assist the pilot in in-flight navigation. For example, the FMS can use a GPS and a navigational database 140 to guide the aircraft 110 along a flight route. The FMS 150 may be implemented using any combination of hard ware, software and firmware. For example, the FMS 150 may use a processor (not illustrated) and may be connected to various sensors, such as a GPS and/or an inertial navigation system (“INS”) (not illustrated) and the navigational database 140 to guide the aircraft along the flight plan.

The FMS may also include a takeoff and landing (“TOLD”) system 152. The TOLD system 152 can reduce pilot workload by automatically computing takeoff and landing data. The TOLD system 152, for example, can compute V-speeds and runway length requirements. The runway length requirements can vary depending upon, for example, the take off speed of the aircraft 110, the configuration of the aircraft 110, wind speed and direction and other weather conditions. The TOLD system 152 can also account for obstacle clearance, validate the configuration of the aircraft during takeoff and landing and account for any potential aircraft limitations. The FMS 150 and TOLD system 152 may retrieve data, for example, from the navigational database 140 in order to compute the takeoff and landing data. The TOLD system may also rely upon information entered by a pilot or other crew member to perform the computations, as described in further detail below. The pilot and other crew members may interact with the FMS 150 and TOLD system 152 using, for example, the MCDU.

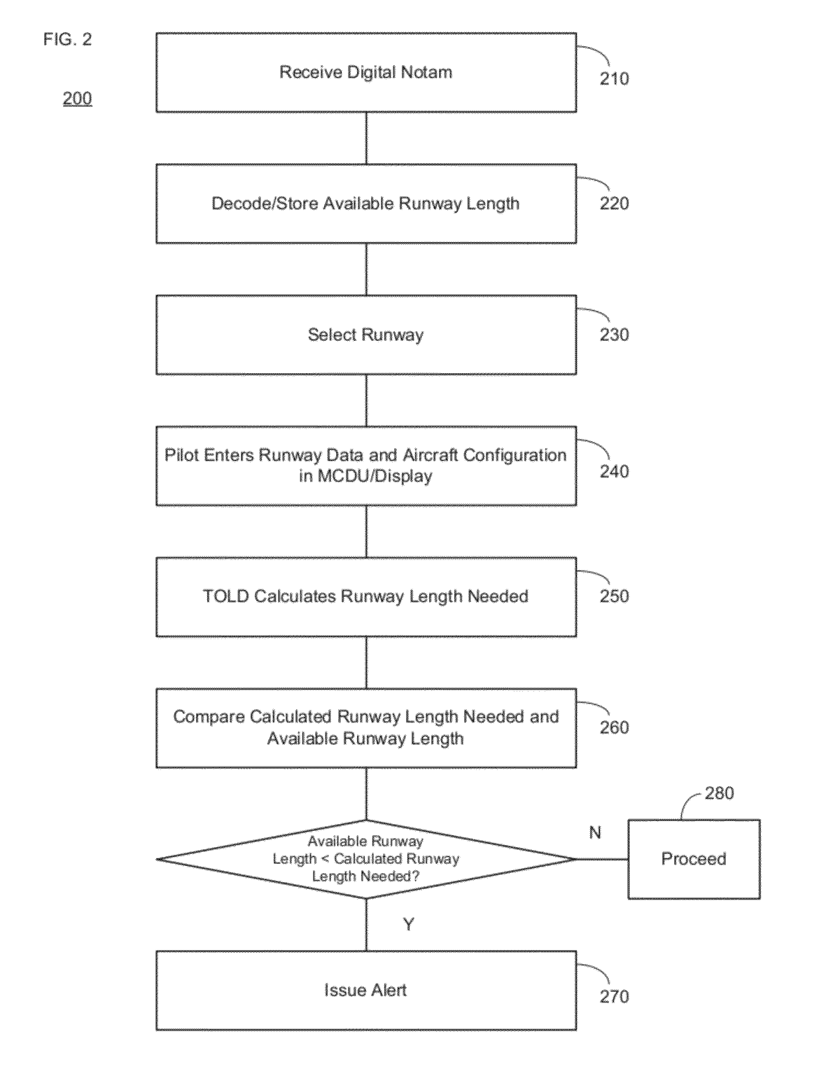

FIG. 2 illustrates an exemplary method 200 for verifying that an available runway length meets the requirements for an aircraft during takeoff or landing, in accordance with an embodiment. The system 100 may first receive a digital NOTAM from a ground communications system 170. (Step 210). The digital NOTAM may be encrypted and broadcast over a predetermined frequency (or over multiple frequencies) at any time. While the method illustrates receiving the digital NOTAM as a first step, the digital NOTAM may be received at any time along the processes. Furthermore, the digital NOTAM may be transmitted multiple times over the process, allowing for multiple runway length checks prior to take off or landing as well as ensuring that the FMS 150 has the most accurate and up to date information.

The FMS 150, after receiving the digital NOTAM, decodes the digital NOTAM, extracts the available runway length for at least one runway and stores the available runway length in the NOTAM database 130. (Step 220). The FMS 150 may, for example, parse the digital NOTAM to locate and extract information determined to be relevant. Each airport may have one or multiple runways. Accordingly, the FMS 150 may decode and store available runway lengths for multiple runways in the NOTAM database 130. The digital NOTAM can be transmitted according to a predetermined format which allows for the NOTAM to be processed quickly and accurately.

In most instances air traffic control (“ATC”) will inform the pilot of the runway that will be used during takeoff or landing for an aircraft 110 as well as the available runway length for that runway. The ATC may, for example, use voice communications over a radio frequency to inform the pilot, or may use other techniques. Once the pilot has been informed of the appropriate runway, the pilot, or other crew member, selects the runway in the runway on the FMS 150. (Step 230).

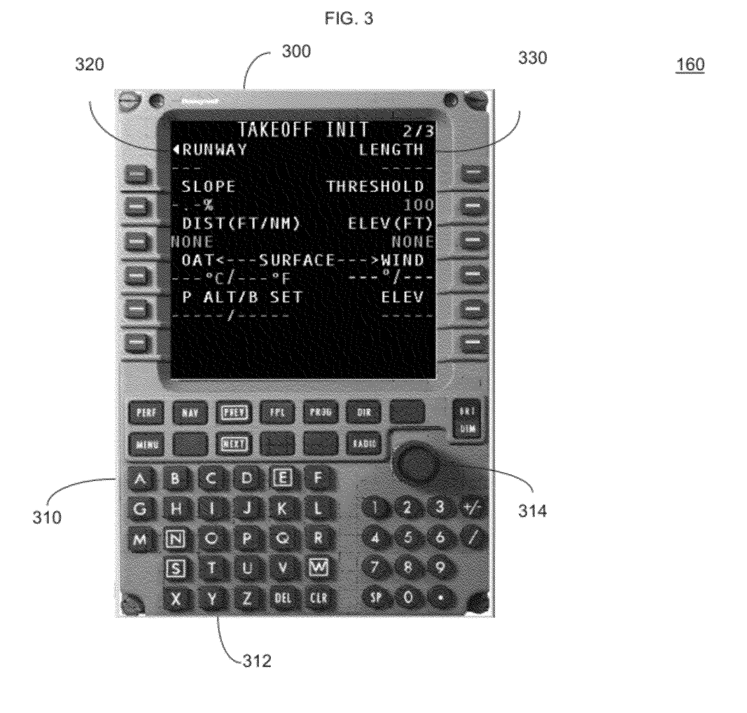

As discussed above, the pilot, or other crew member, can interact with the FMS 150 via a multipurpose control display unit (“MCDU”) 160. FIG. 3 illustrates an exemplary MCDU 160. The MCDU includes a display 300 and an input device 310. The display 300 may be a cathode ray tube, a liquid crystal display, an organic light-emitting diode display, a plasma display or any other type of display. The input device 310 illustrated in FIG. 3 includes a keyboard 312 and a knob 314, however other configurations using other input devices may also be used. For example, the MCDU may be configured to receive input from a touch screen, a mouse, a track ball, voice recognition, and any combination thereof.

In other embodiments, the MCDU 160 may be a virtual MCDU. The display for the virtual device may be rendered on a general purpose electronic display device where the input device 310 and display 300 are electronic, graphical renditions of a physical device. Such electronic display devices may be any type of display device known in the art. Non-limiting examples of a display device may be a cathode ray tube, a liquid crystal display and a plasma screen. However, any suitable display device developed now or in the future is contemplated to be within the scope of this disclosure.

The MCDU 160 also includes a field 320 to display a runway and a field 330 to display a runway length. The pilot, or other crew member, may use the input device 310 to populate fields 320 and 330. In other embodiments the fields 320 and 330 may be populated by data retrieved from navigational database 140 based upon a FMS runway selection. As discussed above, in most instances the ATC will communicate the runway and any changes to the runway length to the pilot via the ground communication system 170. The TOLD system 152, based upon the selected runway in field 320 and available runway length entered in field 330, calculates the V speed and other configurations of the aircraft for the takeoff or landing.

As discussed above, an available runway length is subject to change based upon the condition of the runway as well as from possible personnel or vehicles which may be on a section of the runway. The pilot, if informed by air-traffic control that the available runway length for the selected runway is less than the overall length of the runway, the pilot can enter the reduced length in the TOLD system. (Step 240). The pilot, at step 240, may also enter any aircraft configuration settings which may be used by the TOLD system to calculate the takeoff or landing data. The TOLD system 152 may then calculate takeoff or landing data for the aircraft 110, including the runway length needed for the aircraft to takeoff or land. (Step 250). The TOLD system, as discussed above, may also calculated a V-speed for the takeoff and landing, descend angles and any other data needed for the aircraft to takeoff or land.

After the TOLD system 152 has calculated a length of runway needed for takeoff or landing based upon the parameters entered in steps 230 and 240, the FMS 150/TOLD 152 may verify that the available length of runway, as received in a digital NOTAM, is equal to or greater than the length calculated by the TOLD system 152. (Step 260). While the TOLD system 152 and the FMS 150 also check to make sure that the parameters entered within steps 230 and 240 fall within an acceptable range, the TOLD system 152 and FMS 150 themselves have no way to independently verify if the available length of runway is less than the runways standard total length since the TOLD system 152 and FMS 150 merely rely upon the information stored in database 140 and the information entered by the pilot or other crew member in Step 240. Accordingly, by connecting the NOTAM database 130 to the FMS 150, the FMS 150 and TOLD system 152 can verify the available length of a selected runway. If the needed runway length is greater than the available runway length, the TOLD system 152/FMS 150 may issue an alert to the pilot. (Step 270). The alert may be, for example, an audio and/or visual queue. If the needed runway length is less than the available runway length, the TOLD system will allow the aircraft to continue with the respective takeoff or landing. (Step 280).

Generally speaking, the various functions and features of method 200 may be carried out with any sort of hardware, software and/or firmware logic that is stored and/or executed on any platform. Some or all of method 200 may be carried out, for example, by the FMS 150 in FIG. 1. For example, various functions shown in FIG. 2 may be implemented using software or firmware logic. The particular hardware, software and/or firmware logic that implements any of the various functions shown in FIG. 2, however, may vary from context to context, implementation to implementation, and embodiment to embodiment in accordance with the various features, structures and environments set forth herein. The particular means used to implement each of the various functions shown in FIG. 2, then, could be any sort of processing structures that are capable of executing software and/or firmware logic in any format, and/or any sort of application-specific or general purpose hardware, including any sort of discrete and/or integrated circuitry.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method for verifying an available runway length, comprising:
receiving, by a processor, a digital notice to airmen including an available runway length;
calculating, by the processor, a length of runway needed by an aircraft; and
verifying, by the processor, that the available runway length is greater than or equal to the length of runway needed by the aircraft.

2. The method of claim 1, wherein the calculating further comprises:
receiving, by the processor, a selected runway and a configuration of the aircraft; and
calculating, by the processor, the length of runway needed by the aircraft based upon the selected runway and the configuration of the aircraft.

3. The method of claim 2, wherein the verifying further comprises comparing the available runway length received in the digital notice to airmen with the calculated length of runway needed by the aircraft.

4. The method of claim 3, further comprising displaying a warning on a monitor when the available runway length is less than the calculated length of runway needed by the aircraft.

5. The method of claim 1, wherein the received digital notice to airmen is encoded, and the method further comprises:
decoding, by the processor, the encoded digital notice to airmen;
parsing, by the processor, the decoded digital notice to airmen;
determining a relevancy of the digital notice to airmen and extracting an available runway length for a relevant runway; and
storing, in a memory, the extracted available runway length until its intended expiry.

6. A system for verifying an available runway length for an aircraft, comprising:
a communications system configured to receive a digital notice to airmen including an available runway length; and
a flight management system configured to verify the available runway length is greater than or equal to the length of runway needed by the aircraft based upon a configuration of the aircraft.

7. The system of claim 6, further comprising:
a user interface; and
a takeoff landing system configured to receive a selected runway and the aircraft configuration from the user interface and further configured to calculate a length of runway needed for the aircraft based upon the received selected runway and aircraft configuration.

8. The system of claim 7, wherein the flight management system is further configured to compare the available runway length received in the digital notice to airmen with the calculated length of runway needed for the aircraft to takeoff or land.

9. The system of claim 7, wherein the user interface is a multifunction control display unit.

10. The system of claim 7, wherein the user interface is a virtual multifunction control display unit.

11. The system of claim 6, wherein the digital notice to airmen is encoded.

12. The system of claim 11, further comprising:
a memory,
wherein the flight management system is further configured to:
decode the encoded digital notice to airmen;
parse the decoded digital notice to airmen;
extract the available runway length for the runway; and
store the extracted available runway length in the memory until its intended expiry.

13. An aircraft, comprising:
a communications system configured to receive a digital notice to airmen including an available runway length; and
a flight management system configured to calculate takeoff and or landing data including a length of runway needed to takeoff or land an aircraft, wherein the flight management system is further configured to verify that the available runway length is greater than or equal to the length of runway needed by the aircraft.

14. The aircraft of claim 13, further comprising:
a user interface; and
a takeoff landing system configured to receive a selected runway and an aircraft configuration from the user interface and further configured to calculate a length of runway needed for the aircraft to takeoff or land based upon the received selected runway and aircraft configuration.

15. The aircraft of claim 14, wherein the flight management system is further configured to compare the available runway length received in the digital notice to airmen with the calculated length of runway needed for the aircraft to takeoff or land.

16. The aircraft of claim 14, wherein the user interface is a multifunction control display unit.

17. The aircraft of claim 14, wherein the user interface is a virtual multifunction control display unit.

18. The aircraft of claim 13, wherein the digital notice to airmen is encoded.

19. The aircraft of claim 18, further comprising:
a memory,
wherein the flight management system is further configured to:
decode the encoded digital notice to airmen;
parse the decoded digital notice to airmen;
extract the available runway length for the runway; and
store the extracted available runway length in the memory.

20. The aircraft of claim 16, wherein the multifunction control display unit further comprises a touch screen interface.
